(19) United States
(12) Patent Application Publication
(10) Pub. No.: US 2008/0121834 A1
(43) Pub. Date: May 29, 2008

(54) PLATE VALVE FOR TRACTION ELEMENT TENSIONING SYSTEMS

(75) Inventor: Roman Kern, Forchheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/944,649

(22) Filed: Nov. 26, 2007

(30) Foreign Application Priority Data
Nov. 24, 2006 (DE) 102006055465.5
Oct. 2, 2007 (DE) 102007047170.1

(51) Int. Cl. F16K 1/18

(52) U.S. Cl. 251/331

(57) ABSTRACT

A tensioning system (18) is provided, which interacts with a traction element of a traction element drive via a tensioning rail. The construction of the tensioning system (18) includes a pot-shaped housing (19), which forms a pressure space (20), in which a piston (21) is guided so that it can move longitudinally. For an adjustment movement of the piston (21) in a direction of the pressure space (20), the hydraulic fluid enclosed in the pressure space (20) is regulated by a leakage gap (24). An opposite adjustment movement of the piston (21) causes a return flow of the hydraulic fluid into the pressure space (20) via a one-way valve (1a) integrated in the piston (21). The construction of the one-way valve (1a) includes a cage (2), in which a valve body (3a) constructed as a disk is inserted captively and is guided between a valve seat (5) and a rim (8) so that it can move axially.

### BACKGROUND

The invention relates to a plate valve for a hydraulic tensioning system, which interacts with a traction element of a traction element drive via a tensioning rail. The tensioning system includes a housing, in which a piston is guided that is acted upon by a spring force and which delineates a pressure space filled with a hydraulic fluid. The hydraulic fluid flows into the pressure space via a one-way valve arranged in the housing.

From EP 0 919 744 A1, a tensioning system is known, which includes a disk-shaped valve body as a non-return valve. Here, the valve body is connected to a tappet arranged in a sleeve of a filling body in the interior of the tensioning piston. In the sleeve, the tappet is guided with the intermediate placement of a metal ring exerting a radial force, so that the tappet is displaced with friction. Due to this friction connection between the plate-shaped valve body and the tensioning piston, there is a direct relationship between the opening and closing of the valve body with the motion of the tensioning piston.

According to DE 34 43 183 A1, a plate valve is integrated in a shock absorber, which is designed for vehicles and which controls a control opening designated as a connection between two working chambers of the shock absorber. A spring-mounted valve plate, which is fixed in position at one end and which extends over the control borehole, is used as the plate valve. When the piston performs an adjustment movement, which triggers a vacuum pressure in the pressure chamber of the shock absorber, which houses, among other things, the plate valve, the plate valve opens automatically. After the end or a reversal of this adjustment movement of the piston, the plate valve constructed as a spring-mounted valve plate automatically closes the control opening. Due to the one-sided attachment of the plate valve, this requires a relatively large installation space for the opening, because the spring-mounted valve plate forms a rotational point, about which the valve plate moves with a relatively large radius, in the area of the attachment.

The known plate valves named above have in common a relatively large required installation space, which directly influences the required installation space of the hydraulic valve of the tensioning device.

### SUMMARY

The present invention is based on the objective of providing an economical plate valve with a construction optimized in terms of installation space.

This objective is met according to the invention by a one-way valve, which is constructed as a plate valve and which comprises two components produced without cutting, one a retaining element including a valve seat, in which a valve body constructed as a disk is captively arranged.

The one-way valve according to the invention is thus held in an installation space defined by the retaining element and actuated by the pressure difference between a supply line and the pressure space of the tensioning system. This arrangement offers improved functionality, because the valve body constructed as a disk can move without the influence of other components between an opened and a closed position. Advantageously, through the use of the invention, the one-way valve is not exposed to the mass forces, which influence the opening pressure and which apply force, for example, on the one-way valve for an arrangement within a piston of the tensioning system. The construction of the valve body as a disk also creates a preferred, reduced mass in comparison with a valve body constructed as a ball. In addition, with a valve body constructed as a disk, a desired larger pressure contact surface can be realized, which has an advantageous effect on the functionality of the one-way valve and thus the hydraulic tensioning system.

Advantageous constructions of the invention are described below in the description and claims.

According to a preferred construction of the invention, the retaining element is constructed as a cylindrically shaped cage, which includes a conical base with a central opening. The edge zone of this opening forms a valve seat within the cage, on which the valve body constructed as a disk and acted upon by the hydraulic fluid flow is supported in the sealing function of the one-way valve.

Both the retaining element constructed as a cage and also the valve body constructed as a disk can be produced economically without cutting through stamping and/or a deep-drawing method also in large quantities.

The construction of the cage according to the invention provides that this cage includes at least three axially projecting brackets or a closed rim on the side facing away from the base. After installing the valve body constructed as a disk, the brackets or the rim are bent inward by 90° and thus form an effective captive hold and limit the adjustment path for the valve body.

An unimpaired flow of the hydraulic fluid through the cage is achieved through at least one recess on the outer periphery of the cage body. Preferably, the valve body includes several recesses, which are distributed symmetrically about the periphery and which extend on one side radially past the inner contours of the brackets. On the other side, the recesses do not reach into the contours of the central opening of the cage or its edge zone.

For creating a guided or centered installation position of the valve body within the cage, the valve body forms tabs or projections, which are distributed symmetrically on the outer side and by means of which the valve body can be guided on the inner contours of the cage.

The construction of the plate valve according to the invention allows that this is preferably pressed into a central borehole of the tensioning system housing. For opening the valve, the hydraulic fluid pressurizes the valve body through the central borehole in the base of the cage, which has an advantageous effect on the opening characteristics and thus the function of the tensioning system.

Underlining the compact construction of the one-way valve constructed according to the invention as a plate valve, this features an overall height of ≦5 mm, preferably 3 mm. Included therein is a valve body positioned movably as a disk with a thickness of ≦0.7 mm. Independent from the dimensional specifications noted above, if necessary, one-way valves shaped according to the invention can be used with different overall heights in connection with valve bodies of greater component thickness.

According to the invention, a disk-shaped valve body made from plastic can also be used in a cage made from metal. This measure has an especially positive effect on the noise generation of the one-way valve. To improve the sealing function of the valve body, the invention also includes a valve body, which is provided with an elastomer on at least one side on the valve seat side or is coated locally according to the surface of the valve seat. Alternatively or additionally, according to the invention the edge zone forming the valve seat of the central opening in the base of the cage can be coated, wherein these measures simultaneously stop disadvantageous noise generation by the valve, in addition to an improved sealing effect.

### BRIEF DESCRIPTION OF THE DRAWINGS

The invention will be explained in more detail using embodiments with reference to six drawings. Shown are:

FIG. 1 a view of the one-way valve according to the invention constructed as a plate valve;

FIG. 2 a cross-sectional view of the one-way valve according to FIG. 1 in a section profile designated by 2-2;

FIG. 3 a perspective view of the one-way valve according to FIG. 1;

FIG. 4 a detail view of the valve body constructed as a disk;

FIG. 5 a view of a valve body constructed differently from FIG. 4; and

FIG. 6 a cross-sectional perspective view of a hydraulic tensioning system, in which a one-way valve according to the invention is integrated.

### DETAILED DESCRIPTION OF THE PREFERRED EMBODIMENTS

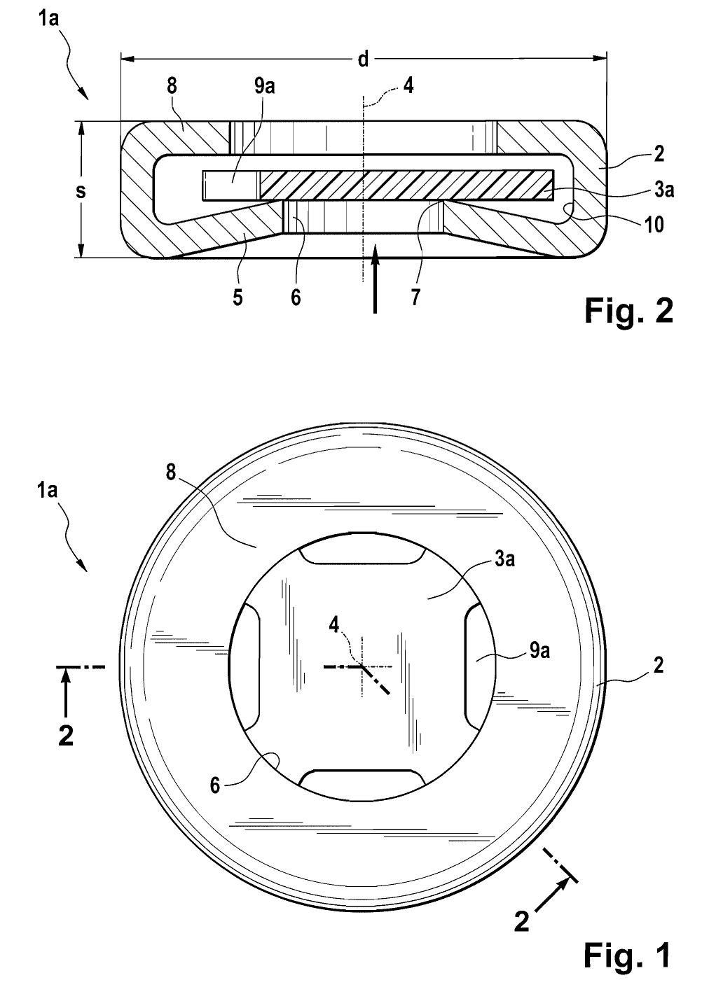

FIGS. 1 and 2 show a rotationally symmetric one-way valve 1a constructed as a plate valve. The construction comprises a housing, which is constructed as a cage 2 and in which a valve body 3a constructed as a disk is inserted with play. The cage 2 constructed without cutting includes a base 5 tapering toward a longitudinal axis 4. An opening 6, on which the valve body 3a is supported in a sealing way on the inside at an edge zone, which forms a valve seat 7, is formed centrally in the base 5. At a distance from the base 5, the cage 2 features a right-angled, peripheral rim 8, which forms a captive holder and simultaneously limits the stroke for the valve body 3a. FIG. 2 shows the one-way valve 1a in a closed position, in which the valve body 3a contacts the valve seat 7 in a sealing manner. When the one-way valve 1a is pressurized with hydraulic fluid in the direction of the arrow, the valve body 3a is displaced to the inside of the rim 8. Local radial recesses 9a on the valve body 3a, which is guided on the outside with play on an inner wall 10 of the cage 2, allow an unimpaired flow of the hydraulic fluid through the one-way valve 1. As taken from FIG. 1, window-like flow cross sections are formed in the region of the recess 9a facing the inside of the rim 8. For the one-way valve 1a, a construction is provided, which provides a diameter/height ratio (d/s) of ≦4.

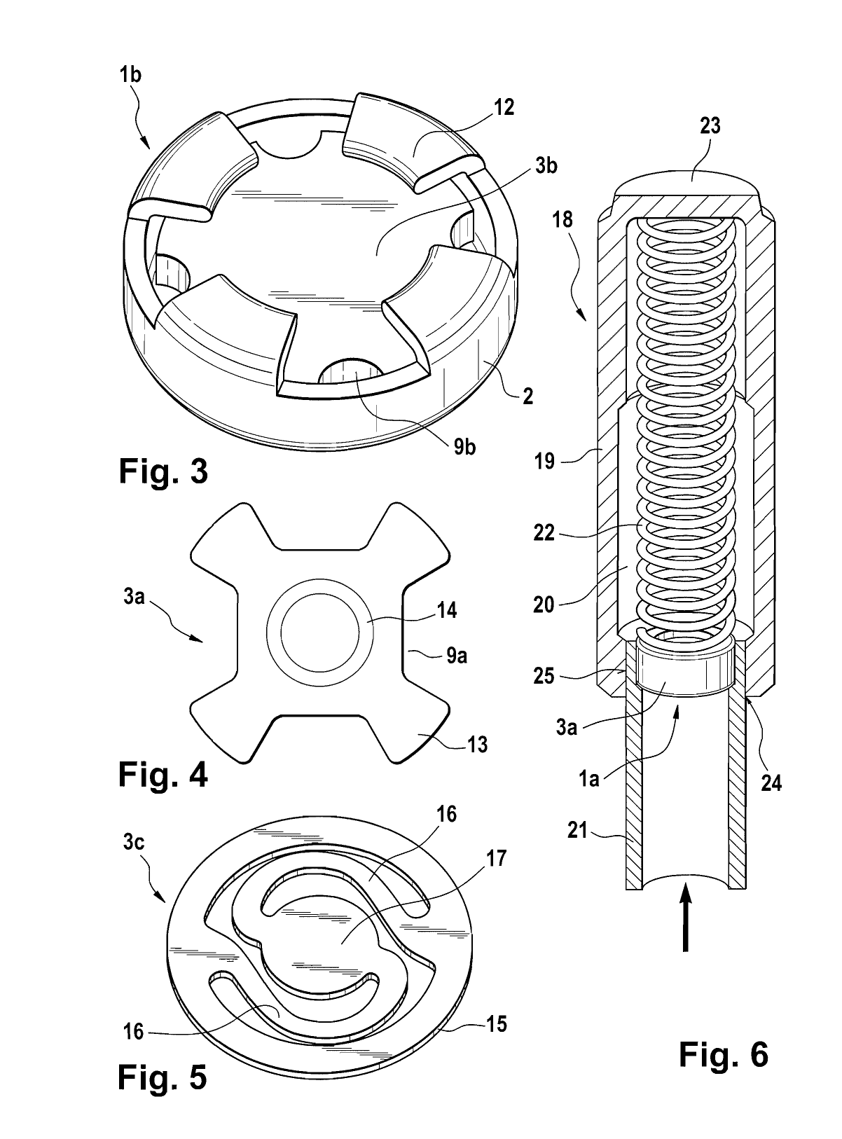

FIG. 3 shows the one-way valve 1b in a perspective view, which includes, different from the one-way valve 1a, four brackets 12, which are distributed around the periphery and which form a stroke limiter or captive hold for the valve body 3b instead of a closed rim 8 according to the one-way valve 1a. The recesses 9a are formed like a semicircle in the outer contours of the valve body 3b.

FIGS. 4 and 5 show the valve bodies 3a, 3c as details. The valve body 3a has nearly cross-shaped outer contour, which are formed by opposing recesses 9a. In the installation position, the valve body 3a is guided by the outer contours formed by guide arms 13 in the cage 2. The annular contours 14 of the valve body 3a form a contact surface, by which the valve body 1a is supported on the valve seat 7 in the one-way valve 1a. For optimizing the sealing quality, the valve body 1a can be coated locally in the region of the annular contours 14, for example, with an elastomer.

The valve body 3c according to FIG. 5 comprises an outer annular element 15, which is connected to a central sealing disk 17 by two connecting bridges 16. The valve body 3c is suitable for installation in a cage, in which the outer annular element 15 is fixed in position between a base and a rim, wherein the central, elastically attached sealing disk 17 interacts with an opening of the base. The installation position provides an exclusive, position-fixed annular element 15. The connecting bridges 16 allow high elasticity of the central sealing disk 17, wherein for flow of the one-way valve through the central base opening of the cage, the valve disk 17 can bulge elastically and thus allows unimpaired flow of the hydraulic fluid through the one-way valve.

In FIG. 6, a hydraulic tensioning system 18 is shown in a longitudinal section. The construction comprises a pot-shaped housing 19, which forms a pressure space 20 delineated by a guided piston 21 that can move longitudinally. A helical compression spring 22 integrated in the pressure space 20 of the housing 19 is supported between a base 23 of the housing 19 and the piston 21. In sync with a displacement of the piston 21 in the direction of the arrow, a corresponding portion of the hydraulic fluid enclosed in the pressure space 20 is discharged via a leakage gap 24 between the outer contours of the piston 21 and an inner wall 25 of the housing 19. A reverse adjustment movement of the piston 21 causes a flow of the hydraulic fluid into the pressure space 20 via the one-way valve 1a integrated in the base of the piston 21.

### LIST OF REFERENCE SYMBOLS

1a One-way valve
1b One-way valve
2 Cage
3a Valve body
3b Valve body
3c Valve body
4 Longitudinal axis
5 Base
6 Opening
7 Valve seat
8 Rim
9a Recess
9b Recess
10 Inner wall
11 One-way valve
12 Bracket
13 Guide arm
14 Annular contours
15 Annular element
16 Connecting bridge
17 Sealing disk
18 Tensioning system
19 Housing
20 Pressure space
21 Piston
22 Helical compression spring
23 Base
24 Leakage gap
25 Inner wall

1. Hydraulic tensioning system, which interacts with a traction element of a traction element drive via a tensioning rail, comprising a housing in which a piston is guided, upon which a spring force is applied and which delineates a pressure space filled with a hydraulic fluid, a one-way valve through which hydraulic fluid can flow into the pressure space and a leakage gap between the housing and the piston through which hydraulic fluid can be discharged, and the one-way valve comprises a plate valve including a retaining element which has a valve seat, and a valve body constructed as a disk guided captively in the retaining element, the retaining element and the valve body being produced without machining.

2. Tensioning system according to claim 1, wherein the retaining element is constructed as a cylindrical cage, which includes a conical base with a central opening, having an edge zone that forms the valve seat within the cage.

3. Tensioning system according to claim 1, wherein the cage includes on a side facing away from a base thereof at least three axially projecting brackets or a closed rim, which are bent inwardly by about 90° after installation of the valve body, creating a captive hold and limiting a stroke for the valve body.

4. Tensioning system according to claim 1, wherein the valve body includes on an outer periphery thereof at least one recess, which guarantees a flow of the hydraulic fluid through the cage for an open one-way valve.

5. Tensioning system according to claim 1, wherein the valve body includes, on an outside thereof, symmetrically distributed guide arms, tabs, or projections, by which the valve body is guided on an inner wall of the cage.

6. Tensioning system according to claim 1, wherein the one-way valve is pressed into a central borehole of the piston.

7. Tensioning system according to claim 1, wherein the cage and the valve body which are formed from sheet metal are deep-drawn or stamped parts.

8. Tensioning system according to claim 1, wherein the one-way valve has an overall height “s” of ≦5 mm.

9. Tensioning system according to claim 1, wherein the valve body has a thickness of ≦0.7 mm.

10. Tensioning system according to claim 1, wherein the valve body is produced from plastic.

11. Tensioning system according to claim 1, wherein at least the valve body has a coating or an elastomer in a region of an annular contour matching a position of the valve seat in the cage.
